(19) United States
(12) Patent Application Publication
(10) Pub. No.: US 2008/0172602 A1
(43) Pub. Date: Jul. 17, 2008

(54) MARKUP LANGUAGE FORMATTED REPORT GENERATION

(76) Inventor: SANDEEP JOSEPH, Ernakulam (IN)

Correspondence Address: SAP AG, 3410 HILLVIEW AVENUE, PALO ALTO, CA, 94304, US

(21) Appl. No.: 11/617,784

(22) Filed: Dec. 29, 2006

(51) Int. Cl. G06F 17/00

(52) U.S. Cl. 715/236; 715/234

(57) ABSTRACT

A method and apparatus for receiving a message that includes a markup language associated with text in the message. Set of formatting instructions for generating a file based on the message are received and amending the markup language in the message responsive to the set of formatting instructions.

### FIELD OF INVENTION

The field of invention relates generally to data processing. In particular, embodiments of the invention relate to modifying metadata about data to include formatting instructions used in generating a report based on the data.

### BACKGROUND

The world wide web uses hypertext transfer protocol (HTTP) for data transmissions between a client computer and a server computer hosting one or more web sites. The HTTP specifies a set of technical rules by which client and server programs can communicate with one another. The HTTP typically is used to transfer data between servers and clients via a browser program (such as Netscape® Navigator® or Microsoft® Internet Explorer®) over the world wide web.

The HTTP was widely adopted as a de facto protocol for navigating the internet, but became limited. A more versatile protocol known as extensible markup language (XML) is commonly used by web designers. The XML specification originates from the World Wide Web consortium (W3C) and is platform, application and vendor independent. The XML is a markup language for documents containing structured information. The Structured information comprises content such as words, pictures and some indication of what role the content plays For example, content in a section heading may have a different meaning from the content in a footnote, which means something different than content in a figure caption or content in a database table.

The XML provides a data standard that can encode the content and semantics of a document. Almost all documents have some structure. A markup language is a mechanism to identify structures in the document. The XML specification defines a standard way to add markup to documents. A document refers not only to traditional documents, but also to other XML data formats, such as vector graphics, e-commerce transactions, mathematical equations, object meta-data, server APIs, and many other kinds of structured information.

There already exists programs for formatting the XML, one of which is file content conversion, which works based on a field separator or field fixed lengths but the messages in this context do not have a field separator such as la comma, colon and the lengths of the various fields are not necessarily uniform.

The File Content Conversion does not provide an option to align a field, For example, to the right, center. As an example, if the length of an amount field is 10 characters and the actual length is 4 characters such as 4325 in the file, the field should appear as 6 space characters followed by the four characters 4325, if right justified.

The File Content Conversion requires specifying the conversion parameters for every format. This can be extremely tedious if there are a large number of flat file formats available.

Thus, there exists a need for a way to automatically flatten and amend an XML file.

### BRIEF DESCRIPTION OF THE DRAWINGS

A better understanding of embodiments of the invention can be obtained from the following detailed description in conjunction with the following drawings, in which:

FIG. 1 illustrates method of amending markup language in the message responsive to the formatting instructions according to one embodiment of the invention.

FIG. 2 provides a block diagram of an embodiment of the invention for formatting instructions and amending the markup language in accordance with an embodiment of the invention.

FIG. 3 provides a block diagram of an embodiment of the invention that generates a flat file in accordance with amended markup language an embodiment of the invention.

### DETAILED DESCRIPTION

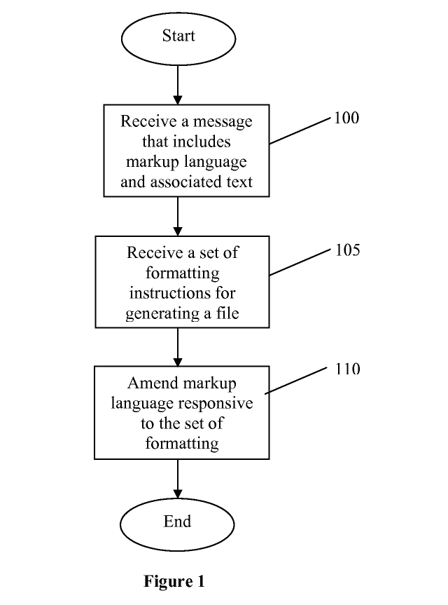

In one embodiment of the invention 100, as shown in FIG. 1, a message that includes markup language and associated records of text is received as input, for example, from a computer network, internet or an intranet. The markup language may be any one of a number of markup languages in use today, such as geography markup language (GML), standard generalized markup language (SGML), hypertext markup language (HTML), extensible markup language (XML) and extensible hypertext markup language (XHTML).

At 105, set of formatting instructions are received based on a common specification for generating a flat file from the message. It may be noted that any person skilled in the art will understand that flat file can be of any format for output file. The set of formatting instructions may contain information such as the width of columns, alignment of the contents, number of decimal places, line breaks, within a particular record. The set of formatting instructions typically provide one or more attribute to associate with the fields in the record, and may also provide one or more attribute to associate with a value for the attribute. The attribute may be, for example, a length of the field, an alignment of the field, or a string indicating the alignment of the field.

The message may be generated by a commercial business application such as financial accounting, banking, or legal applications. A common specification is a data medium exchange (DME) specification. A DME Engine defines file formats that meet the requirements of an institution. For example, in the DME, a file containing all payment information and corresponding to the banking rules for the country in question is generated. For example, banks in Germany require Microsoft's® disk operating system (MS-DOS) files in datentraegeraustausch (DTAUS) format for payments by domestic transfer or direct debits. The DTAUS is used by German credit institutes in order to transfer commands for money exchanges between accounts. This format is used both between banks and between banks and their customers. For these same transactions in the United States of America, automated clearing house (ACH) format is needed, and bankers automated clearing services (BACS) format is used in Great Britain. Depending on the specifications for the DME in the respective country, various methods to store data created by the payment program can be used such as ability to define these formats is particularly important as there is no worldwide or regional standard format. In some cases, no country standard exists and the file must comply with bank-specific standards. Covering such numerous and varied local format requirements is very difficult in standard software, but the DME Engine can enable a particular local format—with little or no programming knowledge or coding.

At 110, the markup language in the message is amended. Amending the markup language includes parsing a record in the message to locate the field for which the set of formatting instructions are provided. The value for the attribute associated with the field are provided for amending the markup language. Then, the flat file is generated at 105 in accordance with the fields and their corresponding set of formatting instructions with respect to the amended markup language.

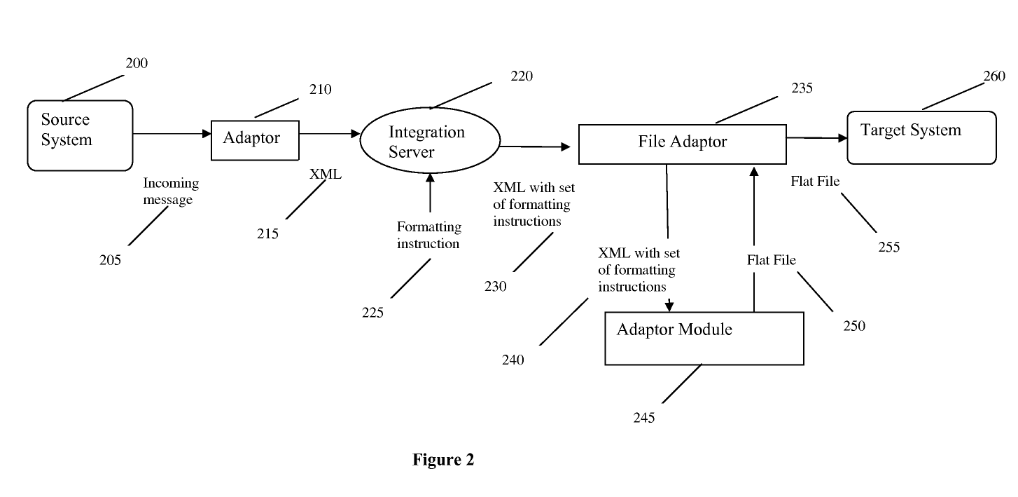

In one embodiment of the invention, as illustrated in FIG. 2, a source system 200 includes a communication network may contain one or more processing systems. The source system 200 can be connected to the internet or be a stand alone system.

An incoming message 205 that includes markup language and associated text is received by adaptor 210 as input from source system 200. The adaptor 210 may include software to connect different networking systems and to enable applications with different interfaces to communicate with each other.

An integration server 220 communicates with applications which are being integrated receiving extensible markup language (XML) 215 from adaptor 210. A set of formatting instructions 225 are received at the integration server 220. The set of formatting instruction 225 may include receiving a common specification for use in generating the file. The set of formatting instructions 225 may also include an attribute to associate with a field in the record. The set of formatting instructions 225 may further include the attribute to associate with a value for the attribute. The common specification is application specific and may include specifications from a data medium exchange (DME) specification.

A file adaptor 235 receives the markup language with the set of formatting instructions 230. An adaptor module 245 is coupled to the file adaptor 235 to amend the markup language with the set of formatting instructions 230 in the message creating the flat file 250 responsive to the set of formatting instructions 225. The set of formatting instructions 225 can contain information such as the width of columns, the alignment of the contents; number of decimal places, line breaks. The adaptor module 245 can be customized and is not limited to use a specific character such as by default space to pad the fields if the length of the content is less than the field width.

The flat file 255 is sent to the target system 260 which can be a computer network internet or intranet.

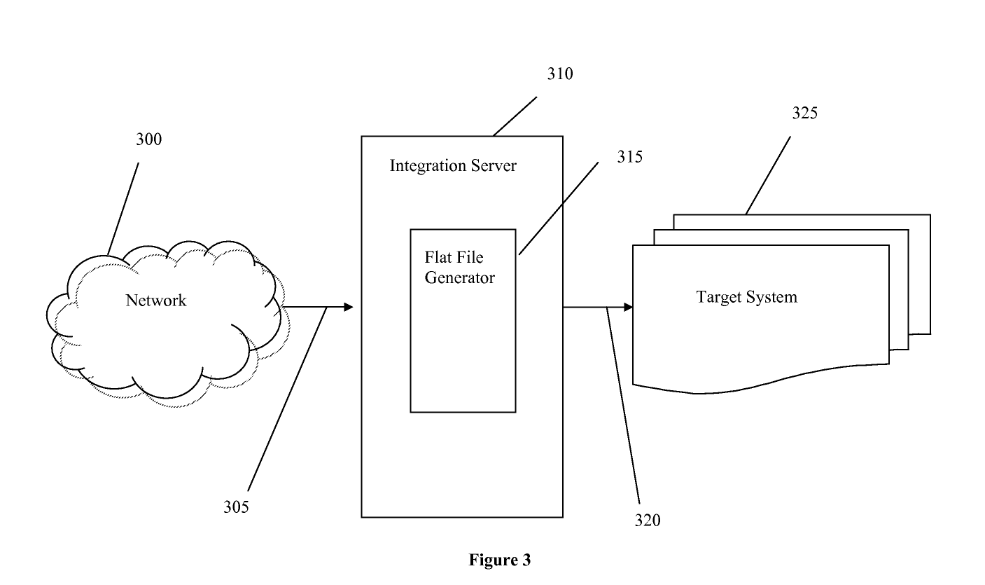

In one embodiment of the invention, as illustrated in FIG. 3, integration server 310 receives a message that includes markup language and associated text 305 from a network 300. The set of formatting instructions along with the message may be received by the integration server 310 and sent to the flat file generator 315. The message may be generated by a commercial business application such as financial accounting, banking, or legal applications. A common specification is a data medium exchange (DME) specification. The set of formatting instructions are based on common specification from the DME. The DME Engine defines file formats that meet the requirements of an institution. For example, in the DME, a file containing all payment information and corresponding to the banking rules for the country in question is generated. For example, banks in Germany require Microsoft's® disk operating system (MS-DOS) files in datentraegeraustausch (DTAUS) format for payments by domestic transfer or direct debits. The DTAUS is used by German credit institutes in order to transfer commands for money exchanges between accounts. This format is used both between banks and between banks and their customers. For these same transactions in the United States of America, automated clearing house (ACH) format is needed, and bankers automated clearing services (BACS) format is used in Great Britain. Depending on the specifications for the DME in the respective country, various methods to store data created by the payment program can be used such as the ability to define these formats is particularly important as there is no worldwide or regional standard format. In some cases, no country standard exists and the file must comply with bank-specific standards. Covering such numerous and varied local format requirements is very difficult in standard software, but the DME Engine can enable a particular local format—with little or no programming knowledge or coding.

The flat file generator 315 amends the markup language in the message, including parsing a record in the message to locate a field for which the formatting instructions are provided from integration server 310, and providing attribute values associated with the field and amending the markup language accordingly. Further, the flat file generator 315 generates the flat file in accordance with the amended markup language. The output flat file 320 is send to the target system 325 which can be a computer or server, directly connected or connected via the internet or intranet.

An example of one embodiment of the invention is provided below in which an input message is received and a flat file is provided as output. However, it should be understood to those of skill in the art that the invention is not limited to the below example. A sample source message and the expected output are given below:

```
<?xml version=“1.0” encoding=“UTF--8”?>
<payment_info>
    <header>
        <name>SAP Labs</name>
        <date>01032006</date>
        <account_number>765679</account_number>
        <bank>ABN Amro</bank>
        <suffix/>
    </header>
    <detail>
        <vendor_name>Hewlett Packard</vendor_name>
        <account_number>587458</account_number>
        <bank>Bank Of America</bank>
        <amount>1500.75</amount>
    </detail>
    <detail>
        <vendor_name>Microsoft</vendor_name>
        <account_number>7429861766</account_number>
        <bank>HSBC</bank>
        <amount>625.90</amount>
    </detail>
    <footer>
        <total_payments>2</total_payments>
        <total_amount>2126.65</total_amount>
        <suffix/>
    </footer>
</payment_info>
```

The above markup language is the content of the source message. This markup language contains the information to make payments to vendors and has three sections, namely:

1. The Header

2. Line Items

3. The Footer

The Header is denoted by the tag <header>. The header section in the message is shown below:

```
<header>
    <name>SAP Labs</name>
    <date>01032006</date>
    <account_number>765679</account_number>
    <bank>ABN Amro</bank>
    <suffix/>
</header>
```

The Line Items are denoted by the <detail> tag. In this example there are two line items, shown below.

```
<detail>
    <vendor_name>Hewlett Packard</vendor_name>
    <account_number>587458</account_number>
    <bank>Bank Of America</bank>
    <amount>1500.75</amount>
</detail>
<detail>
    <vendor_name>Microsoft</vendor_name>
    <account_number>7429861766</account_number>
    <bank>HSBC</bank>
    <amount>625.90</amount>
</detail>
```

The Footer is denoted by the <footer> tag. The footer section is shown below.

```
<footer>
    <total_payments>2</total_payments>
    <total_amount>2126.65</total_amount>
    <suffix/>
</footer>
```

The message includes the information for a company to make payments to its vendors such as Payee/Beneficiary. The header section contains the information of a Payer. In the above example the details of the payer are represented as follows:

| Information | Representation in the Message |
|---|---|
| Payer's Name: SAP Labs | <name>SAP Labs</name> |
| Date: 01-03-2006 | <date>01032006</date> |
| Payer's Account | <account_number>765679</account_number> |
| Number: 765679 | |
| Payer's Bank: ABN | <bank>ABN Amro</bank> |
| Amro | |
| Filler | <suffix/> |

The information to make payment to the vendors (payees) is given in the line items. In this scenario the Payer is paying two payees. So there are two Line items. One message can have any number of line items. Consider the first line item from the message.

| Information | Representation in the Message |
|---|---|
| Payee's Name: Hewlett Packard | <vendor_name>Hewlett Packard |
| | </vendor_name> |
| Payee's Account Number: | <account_number>587458 |
| 587458 | </account_number> |
| Payee's Bank: Bank Of America | <bank>Bank Of America</bank> |
| Amount to be paid: 1500.75 | <amount>1500.75</amount> |

Finally the footer contains a summary of the message.

| Information | Representation in the Message |
|---|---|
| Total Number of payments: 2 | <total_payments>2</total_payments> |
| Total Amount Paid: 2126.65 | <total_amount>2126.65</total_amount> |
| Filler | <suffix/> |

The information in the above markup language is converted to a flat file 255 FIG. 2, by flat file generator 310 FIG. 3, in order to send it to a bank. The bank defines the format of this file. For example, consider the formatting guidelines given by the bank as follows:

Formatting Attributes for the Header:

| Field Name | Field Width | Alignment |
|---|---|---|
| Name | 20 | Left |
| Date | 8 | Left |
| account_number | 10 | Left |
| Bank | 20 | Left |
| Suffix | 2 | NA |

Formatting Attributes for the Details:

| Field Name | Field Width | Alignment |
|---|---|---|
| Vendor_name | 20 | Left |
| account_number | 10 | Left |
| Bank | 20 | Left |
| Amount | 10 | Right |

Formatting Attributes for the Footer:

| Field Name | Field Width | Alignment |
|---|---|---|
| Total payments | 20 | Left |
| Total_amounts | 10 | Right |
| Suffix | 40 | NA |

These guidelines are used to create the flat file 255 FIG. 2, from the markup language message.

The markup language can be provided to the file adapter 235 FIG. 2, is enriched with the set of formatting information 225 FIG. 2, by defining attributes such as length, alignment, for an element. These attributes are optional. The values for the attributes can be provided at the time of amending if the markup language does not contain the above information. The amended markup language provided to the file adapter 235 FIG. 2 is as follows:

```
<?xml version=“1.0” encoding=“UTF--8”?>
<payment_info>
    <header>
        <name length=“20”>SAP Labs</name>
        <date length=“8”>01032006</date>
        <account_number length=“10”>765679</account_number>
        <bank length=“20”>ABN Amro</bank>
        <suffix length=“2”/>
    </header>
    <detail>
        <vendor_name length=“20”>Hewlett Packard</vendor_name>
        <account_number length=“10”>587458</account_number>
        <bank length=“20”>Bank Of America</bank>
        <amount length“=10” align=“right”>1500.75</amount>
    </detail>
    <detail>
        <vendor_name length=“20”>Microsoft</vendor_name>
        <account_number length=“10”>7429861766</
        account_number>
        <bank length=“20”>HSBC</bank>
        <amount length=“10” align=“right”>625.90</amount>
    </detail>
    <footer>
        <total_payments length=“10”>2</total_payments>
        <total_amount length=“10” align=“right”>2126.65</
        total_amount>
        <suffix length=“40”/>
    </footer>
</payment_info>
```

After performing the above mentioned process the flat file generator 310 FIG. 3, generates the output flat file 320 FIG. 3, and sends it to the target system 325 FIG. 3. The output flat file 320 FIG. 3, is shown below.

[Spaces are denoted by ‘•’ and new lines by [symbol] ].

SAP.Labs............01032006765679....ABN.Amro.............. [symbol]
Hewlett .Packard....587458....Bank.Of.America........1500.75 [symbol]
Microsoft...........7429861766HSBC....................625.90 [symbol]
.........2...2126.65........................................

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method comprising:
receiving a message that includes a markup language associated with text in the message;
receiving a set of formatting instructions for generating a file based on the message; and
amending the markup language in the message responsive to the set of formatting instructions.

2. The method of claim 1, wherein the markup language is selected from a group of markup languages consisting of GML, SGML, HTML, LaTeX, XML and XHTML.

3. The method of claim 1, wherein receiving the set of formatting instructions comprises receiving a common specification for use in generating the file.

4. The method of claim 3, wherein the common specification is application specific.

5. The method of claim 3, wherein the common specification comprises of a Data Medium Exchange (DME) specification.

6. The method of claim 3, wherein the common specification provides the set of formatting instructions for use in generating a record in the file.

7. The method of claim 6, wherein the set of formatting instructions provide an attribute to associate with a field in the record.

8. The method of claim 6, wherein the set of formatting instructions provide the attribute to associate with a value for the attribute.

9. The method of claim 8, wherein the attribute is selected from a group consisting of a length of the field, an alignment of the field, and a string indicting the alignment of the field.

10. The method of claim 1, wherein amending the markup language in the message comprises:
parsing a record in the message to locate the field for which the set of formatting instructions provide the attribute;
providing value for the attribute associated with the field; and
amending the markup language for the field to include the attribute.

11. The method of claim 10, further comprising generating the file according to amending the markup language.

12. The method of claim 11, wherein the attribute in the file are generated according to the Data Medium Exchange (DME) specification.

13. The method of claim 10, wherein amending the markup language in the message further comprises:
filtering the attribute;
parsing a record in the message to locate the field for which the set of formatting instructions provide the attribute for filtering the attribute; and
providing value for the attribute associated with the field.

14. An article of manufacture, comprising:
an electronically accessible medium including instructions, that when executed by a processor, cause the processor to:
receiving a message that includes a markup language associated with text in the message;
receiving a set of formatting instructions for generating a file based on the message; and
amending the markup language in the message responsive to the set of formatting instructions.

15. The article of claim 14, wherein the markup language is selected from a group of markup languages consisting of GML, SGML, HTML, LaTeX, XML and XHTML.

16. The article of claim 14, wherein receiving the set of formatting instructions comprises receiving a common specification for use in generating the file.

17. The article of claim 16, wherein the common specification is application specific.

18. The article of claim 16, wherein the common specification comprises of a Data Medium Exchange (DME) specification.

19. The article of claim 16, wherein the common specification provides the set of formatting instructions for use in generating a record in the file.

20. The article of claim 19, wherein the set of formatting instructions provide an attribute to associate with a field in the record.

21. The article of claim 19, wherein the set of formatting instructions provide the attribute to associate with a value for the attribute.

22. The article of claim 21, wherein the attribute is selected from a group consisting of a length of the field, an alignment of the field, and a string indicting the alignment of the field.

23. The article of claim 14, wherein amending the markup language in the message comprises:
parsing a record in the message to locate the field for which the set of formatting instructions provide the attribute;
providing value for the attribute associated with the field; and
amending the markup language for the field to include the attribute.

24. The article of claim 23, further comprising generating the file according to amending the markup language.

25. The article of claim 24, wherein the attribute in the file are generated according to the Data Medium Exchange (DME) specification.

26. The article of claim 23, wherein amending the markup language in the message further comprises:
filtering the attribute;
parsing a record in the message to locate the field for which the set of formatting instructions provide the attribute for filtering the attribute; and
providing value for the attribute associated with the field.

27. A system comprising:
an integration server to receive a message that includes markup language associated with text in the message,
an adaptor module coupled to the integration server to convert the message into a file based on a set of formatting instructions; and
amending the markup language in the message responsive to the set of formatting instructions.

28. The system of claim 27, wherein the markup language is selected from a group of markup languages consisting of GML, SGML, HTML, LaTeX, XML and XHTML.

29. The system of claim 27, wherein a generator generates the set of formatting instructions received from the integration server according to attributes.

30. The system of claim 27, further comprising:
a file adaptor to receive the set of formatting instructions from the integration server and forward the set of formatting instructions to the adaptor module.

31. The system of claim 30, further comprising:
the adaptor module to create a file structure responsive to the set of formatting instructions and transfer the file to the file adaptor.

32. The system of claim 30, wherein the file adaptor transfers the file to a specified destination.

33. The system of claim 29, wherein the attributes in the file are generated according to a Data Medium Exchange (DME) specification.
